(19) United States
(12) Patent Application Publication
(10) Pub. No.: US 2009/0169760 A1
(43) Pub. Date: Jul. 2, 2009

(54) COPPER METALLIZATION UTILIZING REFLOW ON NOBLE METAL LINERS

(76) Inventors: Rohan Akolkar, Hillsboro, OR (US); Florian Gstrein, Portland, OR (US); Boyan Boyanov, Portland, OR (US); Sridhar Balakrishnan, Portland, OR (US)

Correspondence Address: INTEL CORPORATION;c/o CPA Global, P.O. BOX 52050, MINNEAPOLIS, MN, 55402, US

(21) Appl. No.: 11/968,136

(22) Filed: Dec. 31, 2007

(51) Int. Cl. C23C 4/06; B05D 5/12

(52) U.S. Cl. 427/455; 427/123; 427/125

(57) ABSTRACT

Methods for making copper (Cu) interconnects in semiconductor devices for interconnect dimensions less than 50 nm are described. The processes form Cu interconnects using a sequence of barrier layer, liner layer, and Cu deposition layer depositions, followed by a thermally assisted Cu reflow of the Cu deposition layer, and then a chemical mechanical polish (CMP) to removed excess portions of the reflowed Cu. The liner layer comprises noble metals such as Ru, Ir, Os, Rh, Re, Pd, Pt, and Au. Such processes avoids the formation of voids in copper interconnects with dimensions less than 50 nm.

### FIELD

This application generally relates to integrated circuits (ICs) or semiconductor devices and methods for making and using such devices.

### BACKGROUND

Semiconductor devices are built in semiconductor materials, typically silicon wafers (or substrates), through a series of processes. These processes modify the silicon wafer by building components of the semiconductor devices in the wafer. The various components are electrically connected together using conductive layers, sometimes call metal lines. Some of these processes form a metal interconnect layer to connect separate metal lines together. The combination of the metal lines and the various components together form the desired circuits and are, therefore, are sometimes referred to as integrated circuits.

As the demand for cheaper and faster semiconductor devices increases, so must the density of the semiconductor devices. Semiconductor manufacturers are therefore continuously reducing or shrinking the size of semiconductor devices so they can produce more components and devices for every wafer.

### BRIEF DESCRIPTION OF THE DRAWINGS

The following description can be better understood using the Figures listed below, in which:

FIGS. 1a-1e illustrate a cross-sectional view of a technique for electroplating copper on a physical vapor deposition (PVD) Cu deposition layer where

FIG. 1a illustrates a cross-sectional view after an etching of the dielectric and a barrier layer deposition;

FIG. 1b illustrates a cross-sectional view after a copper layer deposition without voids;

FIG. 1c illustrates a cross-sectional view after a copper layer deposition with voids;

FIG. 1d illustrates a cross-sectional view after electroplating copper;

FIG. 1e illustrates a cross-sectional view after removal of excess copper or overburden;

FIGS. 2a-2e contain views of embodiments of method for making a semiconductor device made using Cu reflow on a liner and a PVD Cu layer where

FIG. 2a illustrates a cross-sectional view after an etching of a dielectric and a barrier layer deposition;

FIG. 2b illustrates a cross-sectional view after a liner layer deposition;

FIG. 2c illustrates a cross-sectional view after a Cu layer deposition;

FIG. 2d illustrates a cross-sectional view after copper reflow on the liner by an anneal; and

FIG. 2e illustrates a cross-sectional view after removal of excess copper or overburden; and

The Figures illustrate specific aspects of the semiconductor devices and associated methods of making and using such devices. Together with the following description, the Figures demonstrate and explain the principles of the semiconductor devices and associated methods. In the drawings, the thickness of layers and regions are exaggerated for clarity. It will also be understood that when a layer is referred to as being “on” another layer or substrate, it can be directly on the other layer or substrate, or intervening layers may also be present. The same reference numerals in different drawings represent the same element, and thus their descriptions will not be repeated.

### DETAILED DESCRIPTION

The following description supplies specific details in order to provide a thorough understanding. Nevertheless, the skilled artisan would understand that the semiconductor devices and methods for making and using such device can be implemented and used without employing these specific details. For example, while the description focuses on semiconductor devices, it can be modified to be used in other electrical devices that are formed using similar methods. Although the description below focuses on metal interconnects between metal lines on a silicon substrate, this process can be applied to other components of a semiconductor device.

The reduction in the size of semiconductor devices (referred to as ‘scaling’) can create defects within the devices during their fabrication. Some current processes for forming metal interconnect layers (or interconnects) are performed by electroplating Cu on a physical vapor deposition (PVD) deposition layer containing Cu. The Cu deposition layer is deposited on a dielectric layer containing trenches where the metal interconnects will be formed. Using a PVD Cu deposition layer in smaller dimension (below 40 nm) leads to excessive voiding when unintended breaks, openings, or gaps exist in the deposition layer.

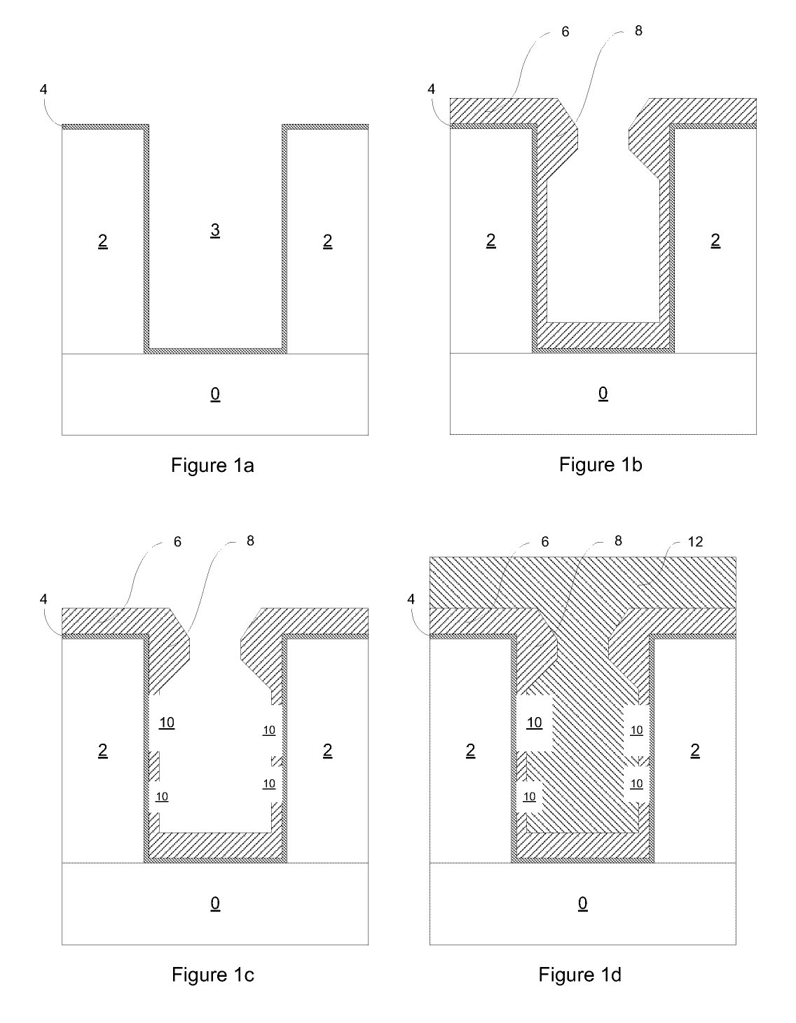

One process of electroplating Cu on a PVD Cu layer is shown in FIGS. 1a-1e. A dielectric layer 2, as illustrated in FIG. 1a, is deposited onto a substrate 0. The dielectric layer 2 is etched to expose trenches. A barrier deposition layer 4 provides a barrier layer to the trenches 3 that have been formed in the dielectric layer.

A copper deposition layer 6, as illustrated in FIGS. 1b and 1c, is deposited using PVD on the barrier layer 4 to provide a conductive layer. The Cu layer allows additional copper to be deposited on and attach to the Cu layer and fill the recessed area of the trenches during electroplating. As shown in FIG. 1b, the Cu layer deposits faster at the openings to the trenches and forms an overhang, bulging, or cusping 8 at the mouth of these openings. This narrows the opening and impairs the copper from adhering to the sidewalls of these trenches, thereby creating discontinuities in the layer on the sidewalls. These discontinuities are called voids 10, as shown in FIG. 1c. As the dimensions of semiconductor devices shrink, the width of the trenches shrink, the overhang 8 at the mouth become larger relative to the size of the trench. Additionally, as the dimensions of the semiconductor devices shrink, it becomes increasingly difficult to maintain continuity of the Cu layer on the trench sidewalls. Discontinuity 10 of the Cu layer leads to exposure of the underlying barrier layer.

When the Cu is electroplated on a Cu layer containing voids 10, the electroplating process electrically attaches copper to the Cu layer 6 and fills the trenches, as illustrated in FIG. 1d. But copper in the electroplated layer 12 does not attach to the exposed barrier layer in regions of the voids. When the excess Cu is removed, the resulting breaks or gaps in the copper interconnect, as shown in FIG. 1e, can impair device performance by increasing resistivity or create electrical opens creating defects in the device or electromigration failures.

Other processes for interconnect metallization contains a series of process enabling a solid copper interconnect to form without voids on a dielectric layer for trench dimensions smaller than about 50 nm, and especially smaller than about 40 nm. In some instances, the solid copper interconnect without voids can be formed for trench dimensions smaller than about 32 nm. The processes form Cu interconnects using a sequence of barrier layer, liner layer, and Cu layer depositions, followed by a thermal Cu reflow of the Cu layer, and then a chemical mechanical polish (CMP) to removed excess portions of the reflowed Cu.

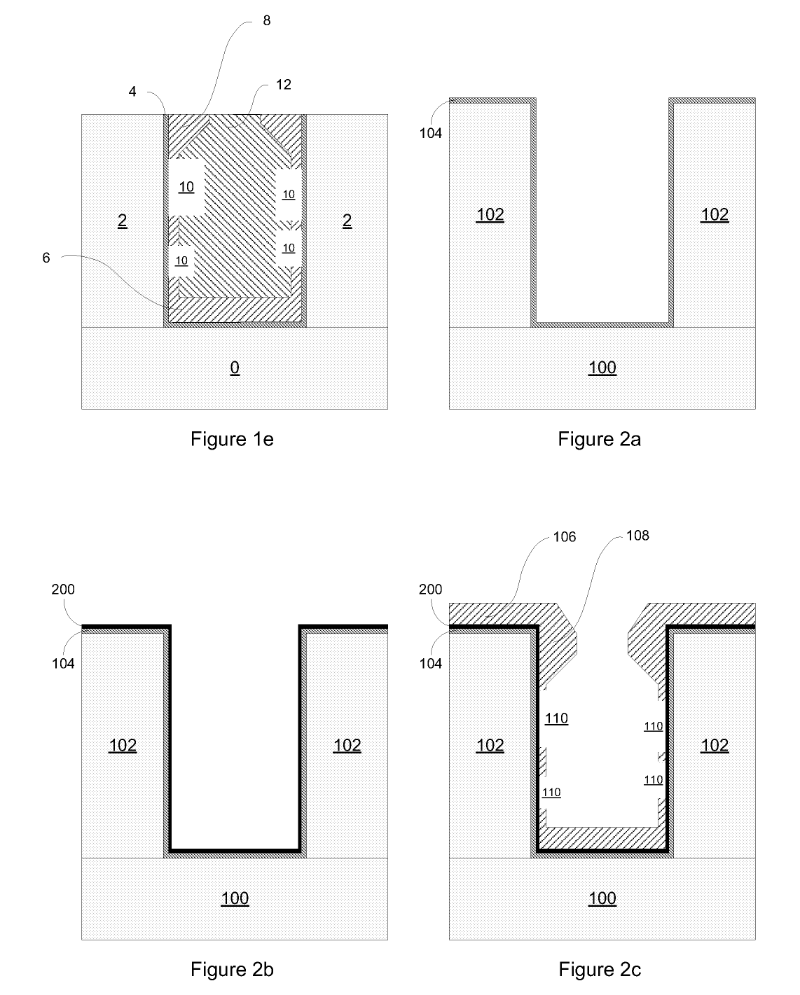

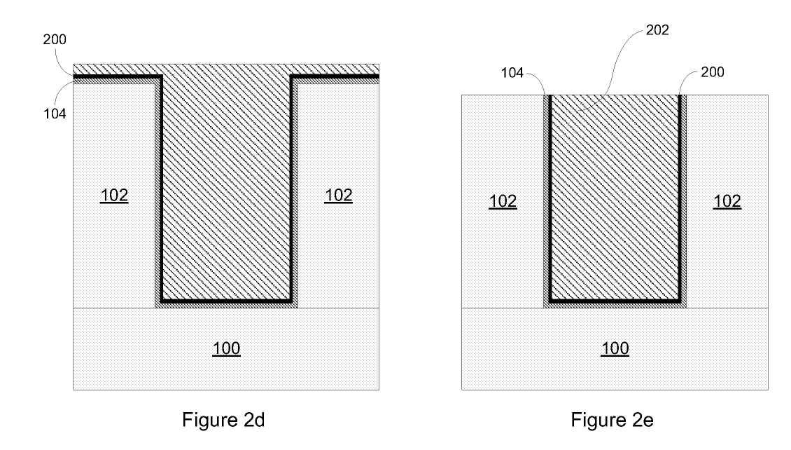

In some embodiments, these processes can be illustrated using FIGS. 2a-2e. The interconnect metallization process usually begins, as known in the art, by using a damascene process. A dielectric layer 102 is deposited onto a substrate 100 which can be a patterned metal layer or another dielectric layer, as shown in FIG. 2a. The dielectric layer 102 is then patterned and etched back so grooves, vias, trenches, or other recessed regions expose a contact area to metal lines in the lower layer 100. This etch can use any conventional etching process to remove the patterned dielectric material. The dielectric layer is then used to provide electrical and physical isolation to subsequently deposited conductive layers. Having the metal interconnects recessed or embedded in a dielectric layer, versus using the subtractive etch process of depositing a metal pattern, etching the metal, and then depositing a dielectric layer, allows the use of a more effective mechanical-chemical etch and polishing process to remove the copper (as described below).

Next, a barrier deposition layer 104 that serves as a protective material is deposited on the dielectric layer 102, shown in FIG. 2a. The barrier layer can be deposited using any conventional deposition method. This barrier layer provides a thin liner to the recessed region in the patterned dielectric layer and prevents the copper from diffusing into the dielectric layer. Copper has the characteristic of diffusing into silicon and other dielectric materials without a barrier and destroying the electrically insulating properties of the dielectrics, which creates device defects. The barrier layer can also improve adhesion between layers, prevent contamination of materials between layers, and improve conductivity. Barrier layers can be formed by the following materials to achieve the any of the properties for a barrier layer stated above: oxides, nitrides, silicon oxynitride, silicon carbide, Mo, MoN, Ta, TaN, W, WN, V, VN, Nb, NbN, Ti, and TiN.

Next, a liner deposition layer 200 comprising a noble metal is deposited on the barrier layer 104, as shown in FIG. 2b. The liner can be deposited using any conventional deposition method. The liner provides wetting of the later applied Cu deposition layer 106 so the copper will flow (in a reflow process) to remove discontinuities or voids 110 of the Cu deposition layer. The surface interaction of Cu with noble metals is unique in that Cu likes to wet the surface of noble metals, like Ru, with contact angles of less than 20 degrees during a later reflow step. Therefore, under appropriate thermal stress, Cu can diffuse on the noble metal in the liner and migrate preferentially to locations where it minimizes the surface energy or tension. This unique gap-fill ability can be used in narrow features. The noble metals that can be used in the liner include but are not limited to: Ru, Ir, Os, Rh, Re, Pd, Pt, Au, and combinations thereof.

Next, a thick copper deposition layer 106 is deposited using PVD on the liner deposition layer 200 to provide the conductive fill for the metal interconnect, as shown in FIG. 2c. The PVD process deposits copper with the fewest impurities introduced during the deposition process. Fewer impurities results in lower resistivity and better device performance. Although PVD processes can be used to deposit the copper, any process that deposits the copper metal can also be used. The Cu deposition layer tends to deposit faster at the openings to the recessed region to form an overhang, bulging, or cusping 108 at the mouth of these openings. The overhang narrows the opening and impairs the copper from adhering to the sidewalls and creates discontinuities, or voids 110, in the Cu deposition layer on the sidewalls.

Next, a reflow process is performed which involves heating the copper deposition layer 106, as shown in FIG. 2d. At elevated temperatures, the surface tension of copper in contact with the noble metals causes copper diffusion into the narrow features. During the reflow process, the voids 100 created during the copper deposition process are filled in with the reflowed Cu.

This reflow process can be performed under any conditions that cause the Cu in the deposition layer to reflow. In some embodiments, the reflow process occurs at elevated temperatures from about 100° C. to about 400° C. for a time period between about 120 and about 600 seconds. The environment in the reflow process could comprise a vacuum or an inert or non-reactive gas, including He, N₂, O₂, or combinations thereof. The reflow process could also be done in reactive gas environments, such as pure H₂ or H₂ plasmas or mixtures of H₂ with an inert gas. The reflow process creates a substantially void-free metal interconnect structure that results in lower resistance interconnects, fewer defects, and better device performance.

Finally, excess copper (or over burden) is removed from the surface of the structure to leave only the recessed region (i.e., trench) filled with copper, as shown in FIG. 2e. The excess material can be removed using any process, including any known chemical mechanical polishing (CMP) process. The resulting structure leaves the Cu interconnect located in the trench and substantially planar with the dielectric layer 102. As known in the art, the Cu interconnects can be used to electrically connect a conductive part of substrate 100 with a metal line deposited on the top of the structure shown in FIG. 2e.

These processes can form low-resistance, substantially void-free interconnects. Since reflow utilizes Cu from a physical vapor deposition source (PVD) for deposition, the impurity levels in Cu lines will be very low. The Cu interconnects using PVD contain fewer impurities than interconnects fabricated using conventional electroplating methods, which contain about 100 ppm of detectable S, Cl, C, O impurities. Voids are also eliminated during reflow. The reflow process enables semiconductor devices to reliably shrink down to dimensions below 50 nm, in some embodiments 40 nm, and in other embodiments 32 nm.

This void formation is avoided due to several factors. First, the accumulation or agglomeration of the Cu deposition layer at the trench openings is reduced or eliminated because of the reflow process. Second, using metal liners comprising noble metals allows Cu to diffuse on the noble metal in the liner and migrate preferentially to locations where it minimizes the surface energy or tension, thereby eliminating voids.

Having described the preferred aspects of the semiconductor devices and associated methods, it is understood that the appended claims are not to be limited by particular details set forth in the above description, as many apparent variations thereof are possible without departing from the spirit or scope thereof.

1. A method of forming a metal interconnect in a semiconductor device, comprising:
providing dielectric layer on a substrate;
forming a recessed region in the dielectric layer;
depositing a barrier layer on the surface of the dielectric layer and in the recessed region;
depositing a liner comprising a noble metal on the barrier layer;
depositing a metal layer on the liner, wherein the metal layer comprises copper;
reflowing the metal layer.

2. The method of claim 1, further comprising removing the excess metal layer after reflow, by using chemical mechanical polish.

3. The method of claim 1, wherein the recessed region comprises a groove, via, or a trench.

4. The method of claim 1, wherein the width of the recessed region is about 50 nm or less.

5. The method of claim 1, wherein the liner comprises Ru, Ir, Os, Rh, Re, Pd, Pt, Au, or combinations thereof.

6. The method of claim 1, including carrying out the reflow process in an environment comprising a forming gas including He, N₂, O₂, or combinations thereof.

7. The method of claim 1, including carrying out the reflow process in an environment comprising a reactive environment of pure H₂, H₂ plasmas, or mixtures of H₂ with an inert gas.

8. The method of claim 1, including carrying out the reflow process for a time in the range of about 120 to about 600 seconds and at a temperature in the range of about 100° C. to about 400° C.

9. A metal interconnect for a semiconductor device formed by the method comprising:
providing dielectric layer on a substrate;
forming a recessed region in the dielectric layer;
depositing a barrier layer on the surface of the dielectric layer and in the recessed region;
depositing a liner comprising a noble metal on the barrier layer;
depositing a metal layer on the liner, wherein the metal layer comprises copper;
reflowing the metal layer.

10. The metal interconnect of claim 9, the method further comprising removing the excess metal layer after reflow, by using chemical mechanical polish.

11. The metal interconnect of claim 9, wherein the width of the recessed region is about 50 nm or less.

12. The metal interconnect of claim 9, wherein the liner comprises Ru, Ir, Os, Rh, Re, Pd, Pt, Au, or combinations thereof.

13. The metal interconnect of claim 9, the method further comprising carrying out the reflow process in an environment comprising a forming gas including He, N₂, O₂, or combinations thereof.

14. The metal interconnect of claim 9, the method further comprising carrying out the reflow process in an environment comprising a reactive environment of pure H₂, H₂ plasmas, or mixtures of H₂ with an inert gas.

15. The metal interconnect of claim 9, the method further comprising carrying out the reflow process for a time in the range of about 120 to about 600 seconds and at a temperature in the range of about 100° C. to about 400° C.
